(19) United States
(12) Patent Application Publication
(10) Pub. No.: US 2011/0059215 A1
(43) Pub. Date: Mar. 10, 2011

(54) MANUFACTURING METHOD FOR THEAFLAVINS USING RAW TEA LEAVES

(75) Inventor: Masumi Takemoto, Shizuoka (JP)

(73) Assignee: SHIZUOKA PREFECTURAL UNIVERSITY CORPORATION, Shizuoka-shi, Shizuoka (JP)

(21) Appl. No.: 12/934,734

(22) PCT Filed: Mar. 27, 2009
(86) PCT No.: PCT/JP2009/001393

§ 371 Date: Nov. 23, 2010

(30) Foreign Application Priority Data
Mar. 28, 2008 (JP) 2008-087500

(51) Int. Cl. A23F 3/16; A23F 3/18

(52) U.S. Cl. 426/429; 426/435

(57) ABSTRACT

Disclosed is a method for cheaply and easily producing theaflavins. After adding a large quantity of water to raw tea leaves that have not undergone wilt treatment, the tea leaves are crushed in a blender and then let stand, shaken, or agitated, thereby efficiently convening four types of catechins in the raw tea leaves to theaflavins. After adding water and crushing the raw tea leaves, letting the tea leaves stand allows theaflavins to be selectively obtained with high yield. Shaking the raw tea leaves which have had water added and been crushed allows four types of theaflavins to be obtained with high yield. The generated theaflavins can be easily collected using a method such as extraction by organic solvent.

### RELATED APPLICATION

This application claims priority based on Japanese Patent Application No. 2008-87500 filed 28 Mar. 2008, the contents of which are hereby incorporated by reference.

### TECHNICAL FIELD

1. Technical Field

The present invention relates to a process for preparation of theaflavins.

2. Background Art

Theaflavins are red colored components contained in black tea at about 1%, which primarily include four species; theaflavin (TF), theaflavin-3-O-gallate (TF3-G), theaflavin-3′-O-gallate (TF3′-G), and theaflavin-3,3′-di-O-gallate (TFDG).

The theaflavins are known to have a variety of physiological effects, such as an antibacterial action, an antioxidative action, a blood sugar lowering action, an anti-tumor activity, a platelet aggregation inhibitory action, and an effect against methicillin-resistant Staphylococcus aureus, and are considered to be useful not only as natural colorants, but also as physiologically active substances.

Methods for theaflavin synthesis reported to date include a method that uses potassium ferricyanide (Non-patent Reference 1), a method that uses an enzyme sample (water-insoluble fraction from yabukita young tea) (Non-patent Reference 2), a method that uses a polyphenol oxidase obtained from tea leaves (Non-patent Reference 3), a method that uses various fruit homogenates (Non-patent Reference 4), a method that uses a liquid green tea extract and a liquid plant extract containing a polyphenol oxidase (Patent Reference 1), a method that uses horseradish peroxidase (Non-patent Reference 5), a method in which polyphenol oxidase is brought into contact with processed green tea leaves (Patent Reference 2), a method in which a green tea slurry is treated with tannase and fermented under an argon or nitrogen atmosphere (Patent Reference 3), and a production method in which tea leaf juice is fermented (Non-patent Reference 6). However, the yield of theaflavins is low in all of these methods. Other methods include a method that uses epicatechin and epigallocatechin as starting materials and that employs hydrogen peroxide and peroxidase-containing cultured plant cells (Patent Reference 4) and a method in which cultured tea cells and hydrogen peroxide are added to an aqueous solution of processed tea leaves (Patent Reference 5); however, these methods require expensive starting materials and enzymes.

The reference documents cited in the application are as indicated below. The contents of these documents are hereby incorporated by reference in its entirety.

### Patent Reference 1: Japanese Patent Application Laid-open No. 2002-95415

### Patent Reference 2: Japanese Translation of PCT Application No. 2005-523242

Patent Reference 3: Japanese Patent Application Laid-open No. H11-225672

### Patent Reference 4: Japanese Patent Application Laid-open No. 2007-143461

Patent Reference 5: Japanese Patent Application No. 2007-182217 (not yet laid open)
Non-patent Reference 1: Yoshinori Takino and Hiroshi Imagawa, Agr. Biol. Chem., 27, 319-321 (1963)

### Non-patent Reference 2: Yoshinori Takino and Hiroshi Imagawa, Journal of the Agricultural Chemistry Society of Japan, 37, 417-422 (1963)

### Non-patent Reference 3: Alastair Robertson and Derek S. Bendall, Phytochemistry, 22, 883-887 (1983)

Non-patent Reference 4: Takashi Tanaka, Yayoi Betsumiya, Chie Mine, and Isao Kouno, Chem. Commun., 2000, 1365-1366

### Non-patent Reference 5: Shengmin Sang, Bioorganic & Medicinal Chemistry, 12, 459-467 (2004)

### Non-patent Reference 6: J. Food Eng., 82, 276-283 (2007)

### DISCLOSURE OF THE INVENTION

An object of the present invention is to provide an inexpensive and convenient process for producing theaflavins.

The inventor discovered that the four catechins in fresh tea leaves can be efficiently converted to theaflavins by adding a large amount of water to fresh, unwithered tea leaves and milling with a mixer and then standing or shaking or stirring. Thus, the present invention provides a process for producing theaflavins comprising adding water and/or a green tea leaf liquid extract to fresh tea leaves, milling the leaves in the water; incubating the mixture with standing or shaking or stirring; and recovering theaflavins from the incubation product.

In one embodiment of the present invention, water and/or a green tea leaf liquid extract is added to fresh tea leaves and milled, and then allowed to stand for from 24 to 120 hours, whereby catechins are efficiently converted to theaflavins. Theaflavins can be produced in a higher yield than theaflavin-3-O-gallate, theaflavin-3′-O-gallate, and theaflavin-3,3′-di-O-gallate.

In another embodiment of the present invention, water and/or a green tea leaf liquid extract is added to fresh tea leaves and milled, and then shaken for from 10 minutes to 1 hour, whereby catechins can be efficiently converted to theaflavins to afford a mixture of the four species, theaflavin, theaflavin-3-O-gallate, theaflavin-3′-O-gallate, and theaflavin-3,3′-di-O-gallate.

In another embodiment of the present invention, water and/or a green tea leaf liquid extract is added to fresh tea leaves and milled, and then stirred with a stirrer for from 10 minutes to 8 hours, whereby catechins are converted in good yields to theaflavins to afford a mixture of the four species, theaflavin, theaflavin-3-O-gallate, theaflavin-3′-O-gallate, and theaflavin-3,3′-di-O-gallate, in high yields. The stirring speed may be adjusted to selectively obtain theaflavin or to obtain a mixture of the four theaflavins.

The produced theaflavins are preferably recovered by extraction with an organic solvent, chromatographic separation, sublimation of caffeine and gallic acid from the reaction mixture, or fractional recrystallization by appropriate change of the temperature of the aqueous reaction solution. More preferably, the products are recovered by extracting caffeine from the aqueous reaction solution with chloroform and subsequently extracting the theaflavins with an organic solvent such as ethyl acetate. In another embodiment, the theaflavins are recovered together with caffeine and gallic acid.

The process of the present invention makes possible the efficient production of theaflavins in much inexpensive and convenient way. In addition, one can select production of theaflavin or the selective production of the four theaflavin species by controlling the incubation conditions.

### PREFERRED EMBODIMENT OF THE INVENTION

Theaflavins

Theaflavins mainly include the following four species.

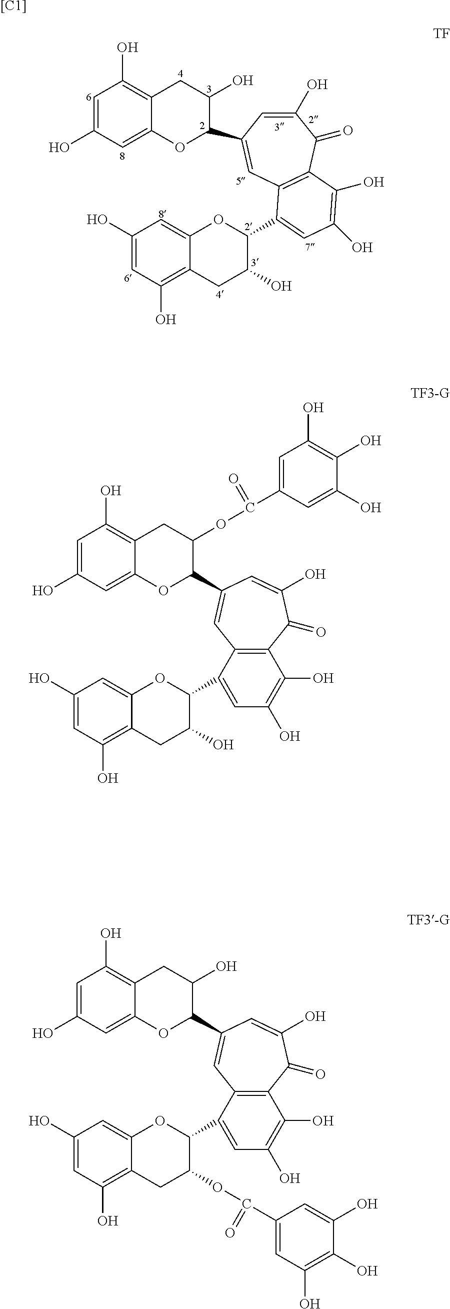

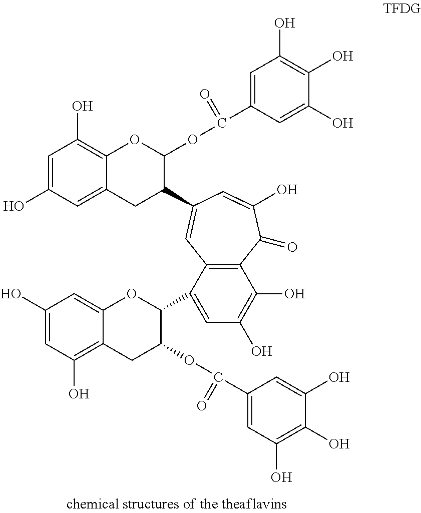

The theaflavins are contained in black tea leaves in the following proportions: theaflavin (TF) 0.08%, theaflavin-3-O-gallate (TF3-G) 0.3%, theaflavin-3′-O-gallate (TF3′-G) 0.2%, and theaflavin-3,3′-di-O-gallate (TFDG) 0.4%.

The Biosynthetic Pathway for Theaflavin

The biosynthetic pathway for theaflavin is given below (Takashi Tanaka, Chie Mine, Kyoko Inoue, Miyuki Matsuda and Isao Kouno, J. Agric. Food Chem., 2002, 50, 2141-2148).

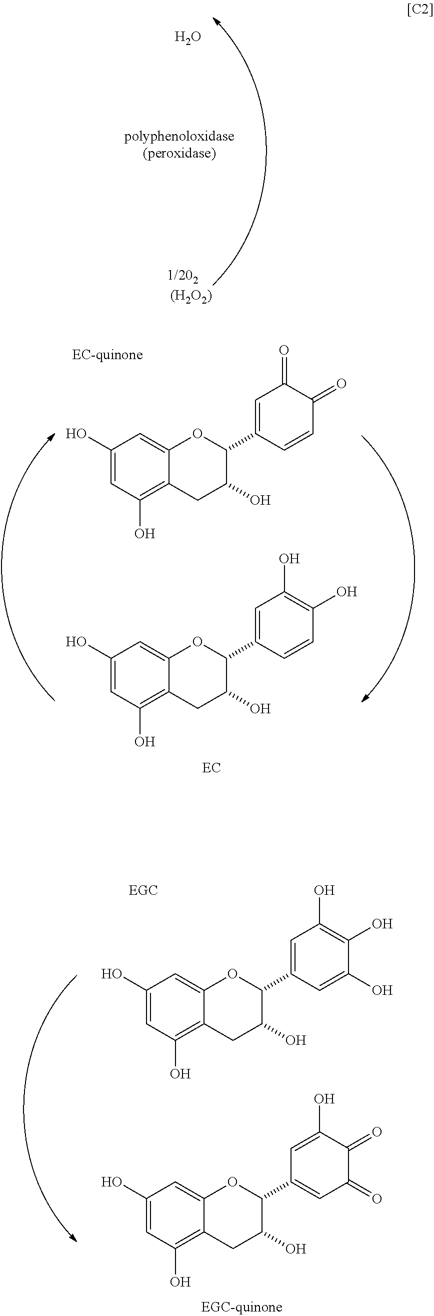

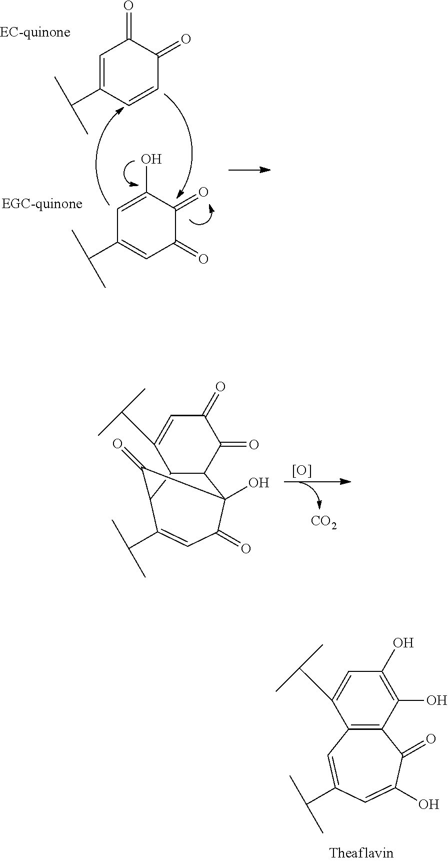

First, epicatechin (EC) is rapidly oxidized by a polyphenol oxidase or peroxidase present in the tea leaf to yield EC-quinone, and the EC-quinone then oxidizes epigallocatechin (EGC) to produce EGC-quinone. Michael addition of the EGC-quinone yielded by the oxidation steps to EC-quinone and subsequent carbonyl addition produce a three-membered ring intermediate, which is converted to a troponoid skeleton through oxidation and decarboxylation reaction, producing theaflavin.

Primarily four catechins (EC, EGC, epicatechin gallate (ECG), and epigallocatechin gallate (EGCG)) are present in tea leaves, and the four theaflavins (TF, TF3-G, TF3′-G, and TFDG) are produced in the production process of black tea, that is, in the fermentation step, by the following catechin combinations via the same pathways as above.

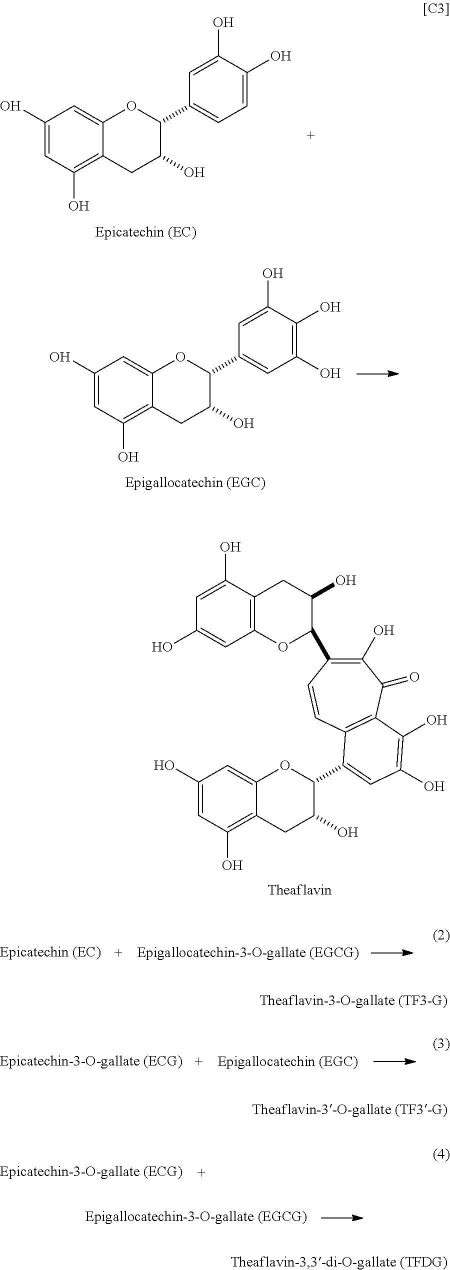

The proportions of the four theaflavins in black tea leaves depend on the content of the starting catechins. Since epicatechin content is lower than that of the other catechins, the theaflavin (TF) level in black tea leaves is as low as 8% of the total theaflavin. Among the four theaflavins, theaflavin (TF) is responsible for the brilliant red color of black tea, and thus black tea leaves with a higher TF content command higher prices.

Starting Materials

The fresh tea leaves used in the process of the present invention refer to tea leaves after harvesting and prior to execution of the withering step, preferably tea leaves that have not been subjected to a milling treatment. The tea leaves encompass both tea leaves and stems, which may be used separately or in combination. The starting fresh tea leaves may be tea leaves of any of the green tea and black tea cultivars in general cultivation. Fresh tea leaves may be frozen immediately after harvesting. The tea leaf harvest may be first flush, second flush, third flush, or fourth flush. The catechin quantities and the activities of the polyphenol oxidase, peroxidase, tannase, and hydrolytic enzymes vary with each of the leaf harvest, thus the process conditions are preferably controlled as appropriate in order to obtain a high yield. When the cost, catechin quantity, enzymatic activity, and so forth are comprehensively evaluated, second flush teas and third flush teas are desirable for the tea leaf used in the process of the present invention.

Differences in Tea Leaf Cultivars

Examples of typical tea leaves in cultivation in Japan are asatsuyu, yabukita, yamatomidori, makinoharawase, kanayamidori, okumidori, ooiwase, okuhikari, meiryoku, samidori, komakage, yamanami, minekaori, hatsumomiji, benifuuki, benihomare, and benihikari. Any tea leaf grown domestically or overseas is suitable for use in the process of the present invention. For example, yabukita tea is a green tea cultivar, while benifuuki and benihomare are black tea cultivars. The main catechins present in the tea leaves are given below.

yabukita tea: EGCG, ECG, EGC, and EC
benifuuki tea: EGCG, ECG, EGC, EC, epigallocatechin-3-(3″-O-methyl)gallate (EGC3″ methyl), epigallocatechin-3-(4″-O-methyl)gallate (EGC4″ methyl), and epicatechin-3-(3″-O-methyl)gallate (EC3″ methyl)
benihomare tea: EGCG, ECG, EGC, EC, EGC3″ methyl, EGC4″ methyl, and EC3″ methyl

Benifuuki and benihomare contain EGC3″ methyl, EGC4″ methyl, and EC3″ methyl, which are not present in yabukita tea. These components are anti-allergy substances regarded as effective in pollen allergies. Benifuuki and benihomare are black tea cultivars, and the EGC3″ methyl, EGC4″ methyl, and EC3″ methyl components will be lost when processed by conventional methods of black tea production.

Differences Due to the Tea Leaf Harvesting Period, from First Flush to Fourth Flush

In the case of first flush, second flush, and third flush yabukita teas, milling with a mixer and standing, shaking, or stirring can be carried out immediately after the leaves are picked or frozen in a refrigerator. On the other hand, the quantity of production of the theaflavins was low when this method was applied to yabukita fourth flush tea. This is believed to be due to a lower enzymatic activity of the polyphenol oxidase and peroxidase or a lower catechin quantity in fourth flush tea than in first, second and third flush teas. Thus, the process indicated above is desirably carried out after the leaves are kept at room temperature for about 2 to 5 days after harvest. When the catechin quantity is low and thus the amount of production of the theaflavins is low, it is desirable to keep the leaves at room temperature for 2 to 5 days and then add water and a coarse tea liquid extract (liquid prepared by extraction of coarse tea with water) to the leaves before the process indicated above.

Preparation Process of Theaflavins

In the process of the present invention, water is added to fresh tea leaves prior to the withering process and milled in water using, for example, a mixer. The mixture is incubated with standing or shaking or stirring without separation of leaves and water. When water is added to the fresh tea leaves and milled, components present in the cells of the tea leaves, e.g., polyphenol oxidase, peroxidase, tannase, hydrolytic enzymes, and various tea components such as catechins and caffeine will leach into the water. When the liquid containing these enzymes and components is allowed to stand or is shaken or stirred, the catechins are converted to theaflavins, and gallic acid is produced by the action of these enzymes. Peroxidase is an enzyme that produces theaflavin in the presence of hydrogen peroxide. In the process of the present invention, hydrogen peroxide need not to be added because it is produced metabolically. Polyphenol oxidase is an enzyme that produces theaflavins in the presence of oxygen. Tannase can cleave off the gallate group of catechins and theaflavins. Cleavage of the gallate group also occurs by the action of hydrolytic enzymes.

Standing Process

In one embodiment of the present invention, water is added to the fresh tea leaves and milled, and then incubated with standing for a predetermined period of time without solid/liquid separation. When water was added immediately after harvesting to fresh, second flush leaves of yabukita tea, milled with a mixer for 1 minute, and incubated with standing for 24 hours TF, TF3G, TF3′G, and TFDG were produced (Example 1). When the mixture was incubated with standing for 120 hours, the catechins were all converted to theaflavin (TF) (Example 2). On the other hand, when the mixture was incubated with shaking after milling with a mixer, other theaflavins were also produced (Example 7).

According to the present invention, when water is added to the fresh tea leaves and milled, components such as polyphenol oxidase, peroxidase, hydrolytic enzymes, and various tea components such as catechins and caffeine will leach into the water. When the liquid containing these enzymes and components is allowed to stand, the supply of oxygen is very limited than in the shaking process. Comparing polyphenol oxidase and peroxidase involved in the theaflavin production, the polyphenol oxidase has less function (polyphenol oxidase catalyzes oxidation reactions in the presence of oxygen and thus does not work in the standing process once the dissolved oxygen in the water has been consumed). While TF3G, TF3′G, and TFDG are produced by standing for 24 hours, the production rates of these theaflavins are less than that in the shaking process (comparison between Example 1 and Example 7). On the other hand, when the mixture is left stand for 120 hours, peroxidase works predominantly due to exhaustion of the oxygen supply. The hydrolytic enzymes also works, and as a consequence the TF3G, TF3′G, and TFDG generated in the 24-hour reaction are hydrolyzed and converted to TF (comparison between Example 1 and Example 2). The following reactions are also believed to proceed at this time. First, TF is produced from EC and EGC by the enzymatic reaction of peroxidase. On the other hand, the ECG and EGCG, are converted to EC and EGC, respectively, by cleavage of the gallate group by tannase or hydrolytic enzymes; and further converted to TF by peroxidase. The hydrolysis reaction is an equilibrium reaction. Since the EC and EGC generated by hydrolysis are converted to theaflavin by peroxidase, the reaction equilibrium is shifted to the right as EC and EGC are consumed, and ECG and EGCG hydrolysis reactions therefore go forward, resulting in complete conversion of the four catechins to theaflavin (TF) after 120 hours.

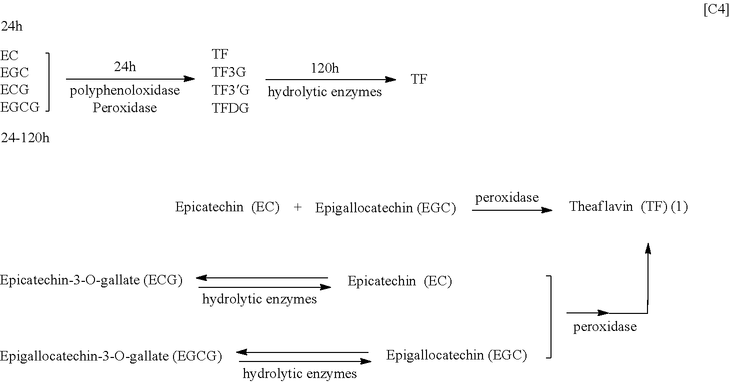

The standing time will vary depending on the type of tea leaf used, the water content, the storage conditions, and so forth, but is preferably at least 12 hours, more preferably at least 24 hours, and even more preferably at least 120 hours. There is no particular upper limit on the standing time, and the reactions can be stopped at a suitable time with monitoring the production of theaflavins. The standing temperature should be within the temperature range in which the enzymes can function, for example, but is not limited to, from 10° C. to 40° C., preferably from 20° C. to 30° C.

Shaking Process

In another embodiment of the present invention, water is added to the fresh tea leaves and milled,

and then incubated with shaking for a predetermined period of time without a solid/liquid separation. When a large quantity of water is added to fresh tea leaves prior to the withering step, milled with a mixer for 1 to 5 minutes, and incubated with shaking for from 10 minutes to 1 hour, the four catechins in fresh tea leaves are completely converted into respective four theaflavins. In the shaking process, both the polyphenol oxidase and peroxidase are functional, and a mixture of the four species, theaflavin, theaflavin-3-O-gallate, theaflavin-3′-O-gallate, and theaflavin-3,3′-di-O-gallate can be obtained.

The shaking time will vary depending on the type of tea leaf used, the water content, the storage conditions, and so forth, but is preferably from 3 minutes to 2 hours and more preferably from 10 minutes to 1 hour. When shaking is further continued after the catechins have been converted to theaflavins, the theaflavins gradually undergo polymerization, resulting in a substantial decline in the yield. The optimal shaking time will vary with the tea leaf used, and those skilled in the art may easily optimize the conditions. The shaking temperature should be within the temperature range in which the enzymes can function, for example, but is not limited to, from 10° C. to 40° C., preferably from 20° C. to 30° C.

Stirring Process

In another embodiment of the present invention, water is added to the fresh tea leaves and milled, and incubated with stirring for a predetermined period of time without solid/liquid separation. The stirring step may be carried out using, for example, a mixer, stirrer, rotating plate, or bottle roller, by operating at a speed that avoids the incorporation of air into the liquid. When a large amount of water is added to fresh tea leaves prior to the execution of withering, milled with a mixer for 1 to 5 minutes, and incubated with stirring for 10 minutes to 8 hours, the four catechins in the fresh tea leaves are entirely converted to the respective four theaflavins. When stirring was done very gently to avoid the incorporation of air, the catechins were entirely converted to theaflavin (TF) (Example 10). At a higher stirring speed, other theaflavins were produced at high levels due to the incorporation of air (Example 11). The stirring process offers the advantage of much shorter reaction time than in the standing process.

Tea Leaf Milling Conditions

Milling step can be carried out at temperatures from 0° C. to 30° C. When the mixture was milled with a mixer for 3 minutes, the content of the theaflavins was substantially increased over that from the 1 minute milling process. The content of the theaflavins was measured after standing for 24 hours and 120 hours. The content of TF3G, TF3′G, and TFDG was reduced after 120 hours relative to that after 24 hours, but not completely converted to TF as in Example 2. This is believed to be due to an increased content of TF3G, TF3′G, and TFDG in the 3 minute shaking step, the hydrolysis reactions did not proceed to completion within 120 hours. An even longer standing time will be required. It is also believed that TF3G, TF3′G, and TFDG are increased in the 3 minutes shaking step, but is not completely hydrolyzed within 120 hours, because the hydrolysis of EGCG and ECG easily proceeds while the hydrolysis of TF3G, TF3′G, and TFDG hardly proceeds (comparison among Examples 2, 4, and 5). The mixer used herein is a household mixer (blender) with a capacity of approximately 700 to 1000 mL and an output power of about 200 to 300 W. When the process of the present invention is scaled up to the industrial production level, those skilled in the art can select a suitable milling time in view of the device used and the quantity to be processed. An example of an industrial production mixer that can be used in the process of the present invention is a commercial mixer (blender) with a capacity of approximately 4000 mL and an output power of about 1400 W, with the revolving speed of high speed (18,500 rpm), medium speed (16,300 rpm), or low speed (14,000 rpm). A custom-made blender may be used when even greater scale is desired, or the mixing process may be repeated in conformity to the quantity of tea leaves. Any device capable of milling can be used to mill the fresh tea leaves, and examples include mixers, ultramizers, hammer mills, homogenizers, and so forth, where mixers (blenders) are particularly preferred.

Quantity of Water

The quantity of water added to the fresh tea leaves can be selected as appropriate depending on the type of tea leaves used, the water content, the storage conditions, and so forth, but is preferably from 5 mL to 500 mL per 1 g fresh tea leaves, more preferably from 7 mL to 200 mL per 1 g fresh tea leaves, and even more preferably from 10 mL to 100 mL per 1 g fresh tea leaves. At less than 5 mL, the product yield will decline, while more than 500 mL will result in a decline in the efficiency of the enzymatic reactions and a reduction in the efficiency of production purification. The content of theaflavin(s) was increased when a large amount of water was used (comparison between Example 2 and Example 3, and comparison between Example 5 and Example 6).

Green Tea Leaf Liquid Extract

Since the catechin quantity in fresh tea leaves is limited, in order to further increase the yield of the theaflavins the process is desirably carried out by addition of water and a green tea leaf liquid extract to the fresh tea leaves or frozen fresh tea leaves. An aqueous solution that contains the four catechins can be used as the green tea leaf liquid extract, for example, a liquid prepared by the addition of water to heat-processed green tea leaves and extraction; a liquid prepared by the addition of water to heat-processed green tea leaves, extraction, concentration to give a tea extract, and addition of water to the tea extract; and a liquid prepared by the addition of water to a tea extract. In this case, both the catechins present in the fresh tea leaves and the catechins present in the green tea leaf liquid extract may be efficiently converted to theaflavin by the action of the enzymes present in the fresh tea leaves, whereby a higher theaflavin(s) content can be obtained.

Purification

The theaflavins thus produced can be readily recovered at high purities by extraction of the aqueous reaction solution with an organic solvent. For example, the theaflavins can be obtained at high purities by removing caffeine by extraction with chloroform and extracting an aqueous phase with an organic solvent such as ethyl acetate or ether. Recovery at high purities can also be achieved by chromatographic separation. Recovery of the theaflavins at high purities can also be achieved by sublimation of the caffeine and gallic acid from the reaction mixture. Recovery of the theaflavins at high purities can also be achieved by fractional recrystallization with suitable change of the temperature of the aqueous reaction solution. While processes of recovering the theaflavins at high purities are described above, in some applications it is also possible to obtain a product in the form of a mixture containing caffeine and gallic acid, without isolating the theaflavins. In such a case, the water may be removed using any techniques well known in the art, for example, spray drying and freeze drying. The type and quantities of the produced theaflavins can be measured in accordance with any conventional methods, for example by HPLC.

The contents of all of the patents and reference documents explicitly cited in the application are hereby incorporated by reference in its entirety.

### EXAMPLES

The present invention is described in greater detail by the examples provided below, but the present invention is not limited by these examples. The contents of EC, ECG, EGC, EGCG, TF, TF3G, TF3′G, and TFDG in the following examples were analyzed using an HPLC instrument (JASCO, PU-980, UV-970) and an ODS120A column (TOSOH, 4.6 mm×250 mm). The HPLC conditions were as follows: solvent=acetonitrile:ethyl acetate:0.05%; H₃PO₄=21:3:76; flow rate=1.0 mL/min; temperature=25° C. Detection with 280 nm UV. The measurements were calculated with respective calibration curves.

### Example 1

100 mL distilled water was added to 9.55 g yabukita tea leaves harvested on 18 July and milled for 1 minute using a household mixer and then transferred to a 100-mL Erlenmeyer flask, which was capped with aluminum foil and allowed to stand for 24 hours. The mixture was filtered by suction filtration to obtain a filtrate, which was analyzed by HPLC. The results were 75.2 mg TF (0.075%), 14.0 mg TF3G (0.014%), 8.0 mg TF3′G (0.008%), 3.9 mg TFDG (0.004%), 3.9 g EGCG (3.9%), 81 mg ECG (0.081%), and 499.7 mg caffeine (0.5%) per 100 g fresh leaves. The filtrate was extracted with chloroform and the aqueous phase was extracted with ethyl acetate to obtain 11 mg theaflavins (per 9.55 g tea leaves).

### Example 2

100 mL distilled water was added to 9.55 g yabukita tea leaves harvested on 18 July and milled for 1 minute using a household mixer and then transferred to a 100-mL Erlenmeyer flask, which was capped with aluminum foil and allowed to stand for 120 hours. The mixture was filtered by suction filtration to obtain a filtrate, which was analyzed by HPLC. The results were 444.8 mg TF (0.44%) and 440 mg caffeine (0.44%) per 100 g fresh leaves. The filtrate was extracted with chloroform and the aqueous phase was extracted with ethyl acetate to obtain 46 mg theaflavin (per 9.55 g tea leaves).

### Example 3

800 mL distilled water was added to 9.55 g yabukita tea leaves harvested on 18 July and milled for 1 minute using a household mixer and then transferred to a 1000-mL Erlenmeyer flask, which was capped with aluminum foil and allowed to stand for 120 hours. The mixture was filtered by suction filtration to obtain a filtrate, which was analyzed by HPLC. The results were 850 mg TF (0.85%) and 435 mg caffeine (0.44%) per 100 g fresh leaves. The filtrate was extracted with chloroform and the aqueous phase was extracted with ethyl acetate to obtain 79 mg theaflavin (per 9.55 g tea leaves).

### Example 4

100 mL distilled water was added to 10.91 g yabukita tea leaves harvested on 18 July and milled for 3 minutes using a household mixer and then transferred to a 100-mL Erlenmeyer flask, which was capped with aluminum foil and allowed to stand for 24 hours. The mixture was filtered by suction filtration to obtain a filtrate, which was analyzed by HPLC. The results were 289 mg TF (0.29%), 70 mg TF3G (0.07%), 42 mg TF3′G (0.042%), 34 mg TFDG (0.034%), 3.1 g EGCG (3.1%), 40.3 mg ECG (0.04%), and 355 mg caffeine (0.36%) per 100 g fresh leaves. The filtrate was extracted with chloroform and the aqueous phase was extracted with ethyl acetate to obtain 42 mg theaflavins (per 10.91 g tea leaves).

### Example 5

100 mL distilled water was added to 10.91 g yabukita tea leaves harvested on 18 July and milled for 3 minutes using a household mixer and then transferred to a 100-mL Erlenmeyer flask, which was capped with aluminum foil and allowed to stand for 120 hours. The mixture was filtered by suction filtration to obtain a filtrate, which was analyzed by HPLC. The results were 402 mg TF (0.4%), 29.3 mg TF3G (0.029%), 14.9 mg TF3′G (0.015%), 9.1 mg TFDG (0.009%), and 307 mg caffeine (0.31%) per 100 g fresh leaves. The filtrate was extracted with chloroform and the aqueous phase was extracted with ethyl acetate to obtain 53 mg theaflavins (per 10.91 g tea leaves).

### Example 6

800 mL distilled water was added to 9.70 g yabukita tea leaves harvested on 18 July and milled for 3 minutes using a household mixer and then transferred to a 1000-mL Erlenmeyer flask, which was capped with aluminum foil and allowed to stand for 120 hours. The mixture was filtered by suction filtration to obtain a filtrate. The filtrate was transferred to a glass bottle, which was capped with aluminum foil, and was then analyzed by HPLC. The results were 699 mg TF (0.7%), 89.5 mg TF3G (0.09%), 24.5 mg TF3′G (0.025%), 38.3 mg TFDG (0.038%), and 435 mg caffeine (0.44%) per 100 g fresh leaves. The filtrate was extracted with chloroform and the aqueous phase was extracted with ethyl acetate to obtain 85 mg theaflavins (per 9.70 g tea leaves).

### Example 7

218 mL distilled water was added to 26.68 g yabukita tea leaves harvested on 15 June and milled for 3 minutes using a household mixer and then shaken for 30 minutes. The mixture was filtered by suction filtration to obtain a filtrate, which was analyzed by HPLC. The results were 176 mg TF (0.18%), 106 mg TF3G (0.11%), 74.0 mg TF3′G (0.074%), 106 mg TFDG (0.11%), 200 mg caffeine (0.20%), 0 g EGCG (0%), and 0 mg ECG (0%) per 100 g fresh leaves. The filtrate was extracted with chloroform and the aqueous phase was extracted with ethyl acetate to obtain 120 mg of the four theaflavins (per 26.68 g tea leaves).

### Example 8

100 mL distilled water was added to 10.00 g second flush benifuuki tea harvested on 23 July and milled for 5 minutes using a household mixer and then shaken for 5 minutes (120 rpm). The mixture was filtered by suction filtration to obtain a filtrate, which was analyzed by HPLC. The results were 257 mg TF (0.26%), 92.7 mg TF3G (0.093%), 49.2 mg TF3′G (0.049%), 48.1 mg TFDG (0.048%), and 495 mg caffeine (0.50%) per 100 g fresh leaves. The filtrate was extracted with chloroform and the aqueous phase was extracted with ethyl acetate to obtain 41 mg of the four theaflavins (per 10.00 g tea leaves).

### Example 9

Yabukita tea leaves harvested on 7 October were allowed to stand for 4 days at room temperature; 140 mL distilled water was then added to 14.76 g of the leaves and milled for 1 minute using a household mixer and then shaken for 37 minutes (120 rpm). The mixture was filtered by suction filtration to obtain a filtrate, which was analyzed by HPLC. The results were 132.4 mg TF (0.13%), 46.0 mg TF3G (0.046%), 33 mg TF3′G (0.033%), 24 mg TFDG (0.024%), and 261 mg caffeine (0.26%) per 100 g fresh leaves. The filtrate was extracted with chloroform and the aqueous phase was extracted with ethyl acetate to obtain 30 mg of the four theaflavins (per 14.76 g tea leaves).

The results from Examples 1 to 9 are given in the following table.

TABLE 1

| | fresh | | Water | | | | | | | | |
|---|---|---|---|---|---|---|---|---|---|---|---|
| No | leaves | weight (g) | (mL) | method | TF (%) | TF 3G (%) | TF3′G (%) | TFDG (%) | EGCG (%) | ECG (%) | Caffeine (%) |
| Example 1 | yabukita | 9.55 | 100 | mixer 1 min | 0.075 | 0.014 | 0.008 | 0.004 | 3.9 | 0.081 | 0.50 |
| | | | | standing 24 h | | | | | | | |
| Example 2 | yabukita | 9.55 | 100 | mixer 1 min | 0.44 | 0 | 0 | 0 | 0 | 0 | 0.44 |
| | | | | standing 120 h | | | | | | | |
| Example 3 | yabukita | 9.55 | 800 | mixer 1 min | 0.85 | 0 | 0 | 0 | 0 | 0 | 0.44 |
| | | | | standing 120 h | | | | | | | |
| Example 4 | yabukita | 10.91 | 100 | mixer 3 min | 0.29 | 0.07 | 0.042 | 0.034 | 3.1 | 0.040 | 0.36 |
| | | | | standing 24 h | | | | | | | |
| Example 5 | yabukita | 10.91 | 100 | mixer 3 min | 0.40 | 0.029 | 0.015 | 0.009 | 0 | 0 | 0.31 |
| | | | | standing 120 h | | | | | | | |
| Example 6 | yabukita | 9.70 | 800 | mixer 3 min | 0.70 | 0.09 | 0.025 | 0.038 | 0 | 0 | 0.44 |
| | | | | standing 120 h | | | | | | | |
| Example 7 | yabukita | 26.68 | 218 | mixer 3 min | 0.18 | 0.11 | 0.074 | 0.11 | 0 | 0 | 0.20 |
| | | | | shaking 30 min | | | | | | | |
| Example 8 | benifuuki | 10.00 | 100 | mixer 5 min | 0.26 | 0.093 | 0.049 | 0.048 | 0 | 0 | 0.50 |
| | | | | shaking 5 min | | | | | | | |
| Example 9 | fourth | 14.77 | 140 | mixer 1 min | 0.13 | 0.046 | 0.033 | 0.024 | 0 | 0 | 0.26 |
| | flush | | | shaking 37 min | | | | | | | |
| | yabukita | | | | | | | | | | |

### Example 10

Heat-processed fourth flush tea (100 g) was extracted with 4 L water and the liquid was added to 200 g frozen tea leaves (tea leaves harvested on 25 June); milled for 1 minute with an industrial mixer (high speed); and incubated with an industrial stirrer for 40 minutes with gentle stirring with keeping unruffled water surfaced. After crude filtration, the resulting filtrate was extracted with chloroform to remove caffeine. The aqueous phase was extracted with ethyl acetate and concentrated to yield 5.2 g theaflavin (80% purity by HPLC analysis).

### Example 11

Heat-processed fourth flush tea (50 g) was extracted with 2 L water and the liquid was added to 100 g frozen tea leaves (tea leaves harvested on 25 June); milled for 1 minute with an industrial mixer (high speed); and incubated with an industrial stirrer for 30 minutes with vigorous stirring to make vortex in the center of the water surface. After crude filtration, the filtrate was extracted once with chloroform. The aqueous phase was extracted with ethyl acetate and concentrated to yield 2.0 g theaflavins (HPLC analysis: 9% caffeine, 24% TF, 18% TF3G, 13% TF3′G, and 15% TFDG).

1. A process for preparing theaflavins, comprising the steps of:
adding water and/or a green tea leaf liquid extract to fresh tea leaves and milling the mixture;
incubating the mixture with standing or stirring without incorporating air; and
recovering theaflavins from the mixture.

2. The process according to claim 1, wherein the incubation is carried out by standing for from 24 hours to 120 hours.

3. (canceled)

4. The process according to claim 1, wherein the stirring is carried out by stirring with a stirrer for from 10 minutes to 8 hours.

5. The process according to claim 1, wherein the theaflavins are recovered by extraction with an organic solvent.

6. The process according to claim 1, wherein the theaflavins are recovered by chromatographic separation.

7. The process according to claim 1, wherein the theaflavins are recovered by sublimation of caffeine and gallic acid from the reaction mixture.

8. The process according to claim 1, wherein the theaflavins are recovered by fractional recrystallization by changing a temperature of an aqueous reaction solution.

9. The process according to claim 1, wherein the theaflavins are recovered together with caffeine and gallic acid.

10. The process according to claim 1, wherein stems of tea leaves are used as the fresh tea leaves.
